(19) United States
(12) Patent Application Publication
(10) Pub. No.: US 2026/0252596 A1
(43) Pub. Date: Aug. 27, 2026

(54) TEXT REPORTING PROCESSING ENGINE, SYSTEM AND METHOD

(71) Applicants: Mohammad ZIA, Amherst, NY (US); Christopher DARLAK, Cambria, NY (US); Benjamin PLESSINGER, Clarence, NY (US); Philip WHALEN, Lockport, NY (US); Carl MORRISON, Fredonia, NY (US); ROSWELL PARK CANCER INSTITUTE CORPORATION HEALTH RESEARCH, INC., Buffalo, NY (US)

(72) Inventors: Mohammad ZIA, Amherst, NY (US); Christopher DARLAK, Cambria, NY (US); Benjamin PLESSINGER, Clarence, NY (US); Philip WHALEN, Lockport, NY (US); Carl MORRISON, Fredonia, NY (US)

(21) Appl. No.: 19/469,810

(22) PCT Filed: Mar. 27, 2024
(86) PCT No.: PCT/US2024/021593

§ 371 Date: Sep. 26, 2025

Related U.S. Application Data
(60) Provisional application No. 63/454,799, filed on Mar. 27, 2023.

(51) Int. Cl. G06F 16/3329; G06F 16/332; G06F 16/335; G06F 16/338

(52) U.S. Cl. CPC G06F 16/3329; G06F 16/3326; G06F 16/335; G06F 16/338

(57) ABSTRACT

Systems (600) and methods (500) for characterizing natural language processing (NLP) allow for user's to refine search results on the fly for use in search unstructured data, while refining a query algorithm for searching. The system provides allows a user to input dynamic quality control with filters that allows for a more accurate results in a timely fashion.

### CROSS-REFERENCE TO RELATED APPLICATION

The present applications claims priority to, and benefit of, U.S. Provisional Patent Application Ser. No. 63/454,799, filed on Mar. 27, 2023, and titled “TEXT REPORTING PROCESSING ENGINE, SYSTEM AND METHOD.” The contents of which are hereby incorporated by reference in their entirety.

### BACKGROUND

### Field

The present disclosure is directed generally to methods and systems for characterizing natural language processing (NLP). This invention's uniqueness, or differentiator, is not the use of specific tools for NLP, but rather the methodology of allowing the user to input dynamic quality control with filters that allows for more accurate results in a timely fashion.

### Background

Various tools/methods exist with a focus on obtaining value/meaning within unstructured documentation. No single tool nor method has captured the market to alleviate the challenges working with unstructured data in a healthcare/health research setting. There is a continued need in the art for more accurate characterization of unstructured documents in healthcare. The digitization of electronic health records has not yet fully solved this problem via discrete (structured) capture of health data, thus making tools capable of successfully querying unstructured data highly sought after. Furthermore, the need for tools capable of handling unstructured data will always be a need in retrospective research analysis of healthcare data as opportunities to capture relevant data discreetly have been lost.

### BRIEF SUMMARY OF THE DISCLOSURE

Accordingly, the present invention is directed to a text reporting processing engine, system and method that obviate one or more of the problems due to limitations and disadvantages of the related art.

In accordance with the purpose(s) of this invention, as embodied and broadly described herein, this invention, in one aspect, relates to a method for characterizing unstructured documents using a combination of natural language processing and user input of quality control and filters, comprising: (i) series of tools to search for unique terms in unstructured documents, (ii) method of presenting results to allow for dynamic quality control with filters, (iii) combination of (i) and (ii) to allow for a more rapid and accurate result for natural language processing.

In another aspect, the invention relates to a system having a memory comprising executable instructions and a processor configured to execute the executable instructions and cause the system to: receive a natural language search query comprising a search term from a user; combine search terms and generate a search query specific to a search engine using the combined terms; run the search query using the search engine, whereby the search engine accesses a repository of unstructured documents to conduct the search to find occurrences of the search term; produce search results comprising a plurality of fragments, wherein each fragment includes the search term plus a predetermined number of words before and after the search term as appearing in each occurrence of the search term; remove unwanted fragments and count the number of times remaining fragments of documents including words; modify the search results as appropriate for display on user graphical user interface; and deliver modified search results to the graphical user interface.

In yet another aspect, the invention relates a method including receiving a natural language search query comprising a search term from a user; combining search terms and generate a search query specific to a search engine using the combined terms; running the search query using the search engine, whereby the search engine accesses a repository of unstructured documents to conduct the search to find occurrences of the search term; producing search results comprising a plurality of fragments, wherein each fragment includes the search term plus a predetermined number of words before and after the search term as appearing in each occurrence of the search term; removing unwanted fragments and counting the number of times remaining fragments of documents including words; modifying the search results as appropriate for display on user graphical user interface; and delivering modified search results to the graphical user interface.

In yet another aspect, a non-transitory computer readable medium comprises instructions that, when executed by a processor of a processing system, cause the processing system to perform a method, the method comprising: receiving a natural language search query comprising a search term from a user; combining search terms and generate a search query specific to a search engine using the combined terms; running the search query using the search engine, whereby the search engine accesses a repository of unstructured documents to conduct the search to find occurrences of the search term; producing search results comprising a plurality of fragments, wherein each fragment includes the search term plus a predetermined number of words before and after the search term as appearing in each occurrence of the search term; removing unwanted fragments and counting the number of times remaining fragments of documents including words; modifying the search results as appropriate for display on user graphical user interface; and delivering modified search results to the graphical user interface

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

An advantage of the present invention is to provide significantly reduced time for processing the search query, on the fly quality control and algorithm refinement, and less manual sorting and study of search results. The present systems and methods take the burden off of human analyzers by performing methods that cannot be performed in the human mind in that the search algorithm itself is refined in the process and processing steps modified based on the patterns performed by a user.

Further embodiments, features, and advantages of the text reporting processing engine, system, and method, as well as the structure and operation of the various embodiments of the text reporting processing engine, system, and method, are described in detail below with reference to the accompanying drawings.

It is to be understood that both the foregoing general description and the following detailed description are exemplary and explanatory only, and are not restrictive of the invention as claimed.

### BRIEF DESCRIPTION OF THE DRAWINGS

The accompanying figures, which are incorporated herein and form part of the specification, illustrate text reporting processing engine, system, and method. Together with the description, the figures further serve to explain the principles of the text reporting processing engine, system, and method described herein and thereby enable a person skilled in the pertinent art to make and use the text reporting processing engine, system, and method.

FIG. 1A shows a search user interface (UI) that allows the user to select a report type to begin searching.

FIG. 1B shows with results of a simple search for the term ‘melanoma’ in the user interface.

FIG. 2 shows various screenshot portions of the user interface.

FIG. 3 shows the functionality in the system to export query result lists in various formats.

FIG. 4 shows the ability for the system to load in the results of an NLP algorithm for quality control purposes.

FIG. 5 illustrates a system flow diagram according to principles described herein.

FIG. 6 illustrates a system diagram according to principles described herein.

FIG. 7 illustrates an exemplary computing environment in which example embodiments and aspects may be implemented.

FIGS. 8-10 show an example initial search user interface (UI) with results and additional tools to refine the results.

### DETAILED DESCRIPTION

Reference will now be made in detail to embodiments of the text reporting processing engine, system, and method with reference to the accompanying figures.

Generally, a method for characterizing unstructured documents according to principles described herein uses a combination of natural language processing and user input of quality control and filters, which may include: (i) series of tools to search for unique terms in unstructured documents, (ii) method of presenting results to allow for dynamic quality control with filters, (iii) combination of (i) and (ii) to allow for a more rapid and accurate result for natural language processing.

An example system according to the principles described herein may be a web-based tool, allowing users to search unstructured documentation in a meaningful manner, allowing mining of free-text data to support research and non-research (operational) activities. While described herein with respect to search pathology reports and radiology reports, any type of unstructured documentation may be searched using the principle described herein. The example system, e.g., search of medical and electronic health record documentation, is designed to:
Provide advanced text searching capability across text-based reports, including historical/legacy cases combined with active reports;
Allow for advanced case-finding not feasible with today's IT systems;
Provide reliable methods to quality control NLP (Natural Language Processing) algorithms for use in complimentary research systems (e.g., detecting triple negative breast cancer cases for use in other research tools);
Create opportunities to research types of diseases not readily available in traditional systems (e.g., basal cell/squamous cell carcinoma of skin, not abstracted in organizational cancer registry systems, significantly limits research on those cases etc.);
Augment existing research data systems with higher quality/more accurate data (e.g., collect cancer staging information directly from pathology reports instead of the cancer registry);
Allow for deeper disease specific research (get deeper into disease specific data within pathology reports, e.g., melanoma cases with ulceration, specific primary lesion thickness etc.).

While described herein a specific medical context, nothing prohibits the present systems and methods from being applied to in other contexts, such as radiology reports, pathology reports, or even outside the medical field. Moreover, while described herein as being web-based, the system could incorporate a stand-alone or closed network implementation of the system and method described herein.

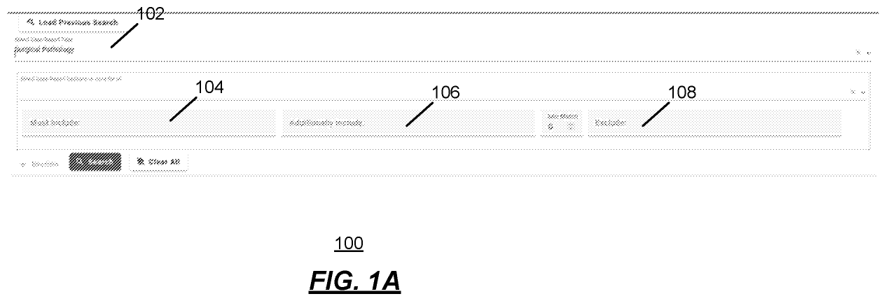

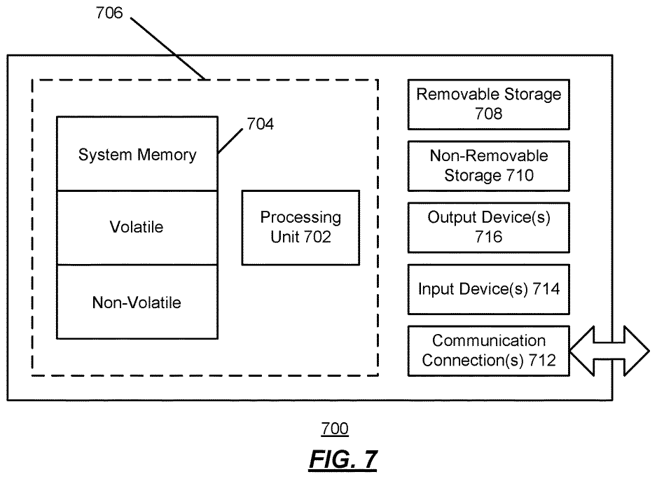

FIG. 1A shows a search user interface (UI) 100 that allows the user to select a report type to begin searching. The user can additionally qualify the search to specific sections in a report type 102. The user can also search multiple sections within a report type with varying criteria per section. The system allows for the user to enter any text term as a basis for the search. The user has 3 options for searching terms (e.g., “must include” 104, “additionally include” 106, and “exclude” 108), which can be used in combination to perform a complex text-based search. Other possible searching bounds may be possible in addition to or as an alternative to these bounds. Depending on the embodiment, the system may be implemented using one or more general purpose computing devices such as the computing device 700 illustrated with respect to FIG. 7.

FIG. 1B shows the results of a simple search for the term 112 ‘melanoma’ (with Personal/Patient Health Information (PHI) redacted from the figure) in the graphical user interface (GUI) 100. The system organizes the data based on the terms being searched via highlighting the term 112, as well as showing a certain number of characters before and after the term (a.k.a. a text fragment 114). The system may also show a count of the number of occurrences 116 that a specific fragment has been utilized throughout the entire document search. The fragment and frequency information aids the user in determining the ‘frequency’ of specific patterns of text to help locate the collection of fragments used to qualify the desired reports. The result may also include the report type 118 that were searched (in this example, “surgical pathology” reports) and the section of a “found” document where the term 112 was found. An ability to ‘hide’ a fragment from the search allows the user to remove from view fragments that are not useful to the goals of the search (i.e., removing the ‘noise’). In the illustrated GUI 200, a toggle button or icon 122 is provided to include “hide” as a functionality.

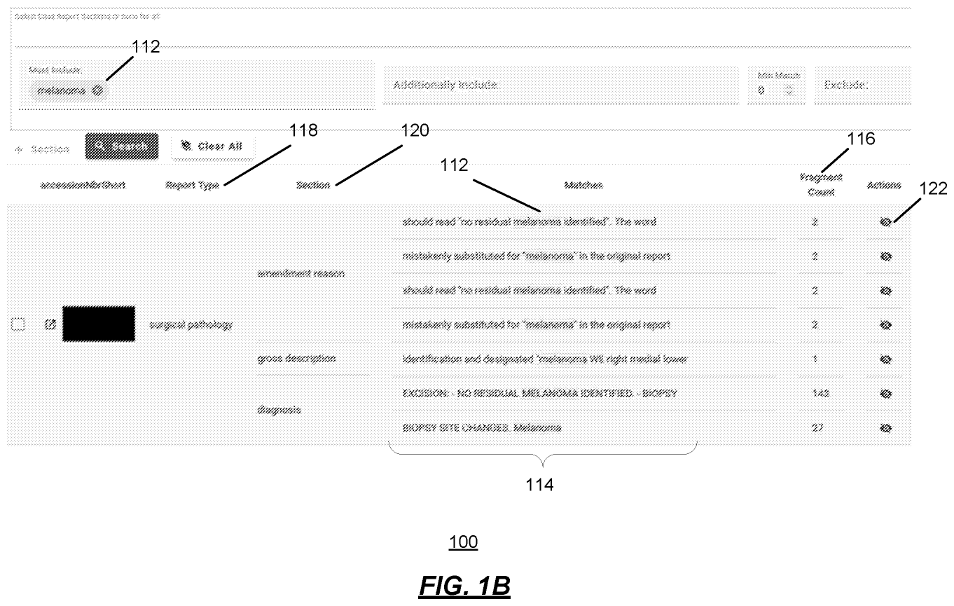

FIG. 2 shows various screenshot portions 210 and 220 of the GUI 200 to illustrate the functionality in the system to review, in a summary fashion, the counts 216 of the specific terms 212 searched as well as a summary of text fragments 214 and related counts 216. The system can also provide hierarchical ordering and sorting features such that the results can be toggled to be in ascending or descending order by any of the information types. This allows the user to understand in a summary and ranked fashion the most used search terms and commonly found fragments of text for the entire search. The user also can hide text fragments using the “hide” toggle 222 in this summary view, which will apply to the entire query result set associated with a particular fragment 214.

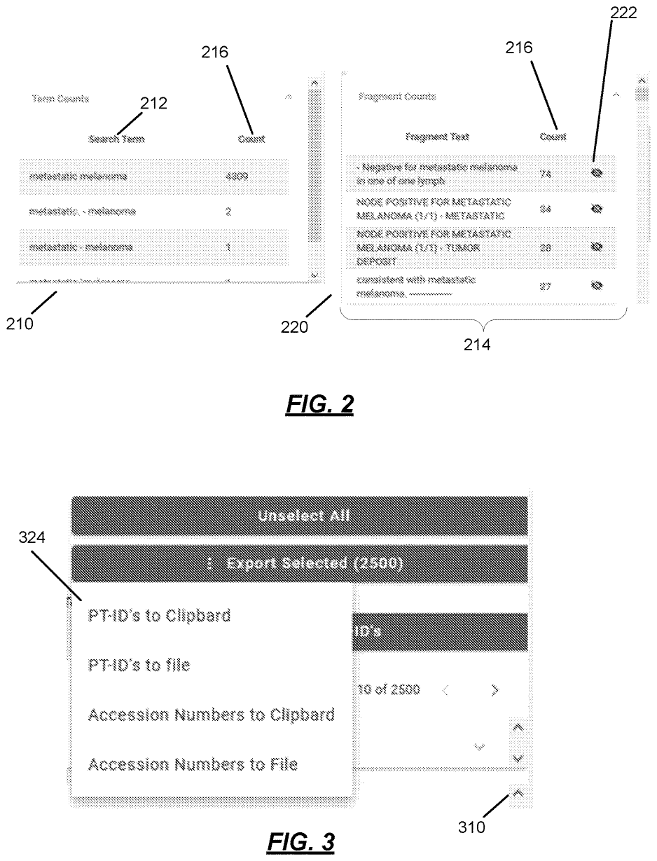

FIG. 3 shows screenshot portion 310 of the GUI 200 to illustrate the functionality in the system to export query result lists in various formats 324. As illustrated, the user may use drop-down menus in the GUI to choose how to export data and what the export may include. For example, the exports are designed to meet varying use cases. Accession number exports may be needed for clinical/operations, while PT-Id exports support research functions. These export lists may then be used in downstream clinical and research systems to further support operational and research needs.

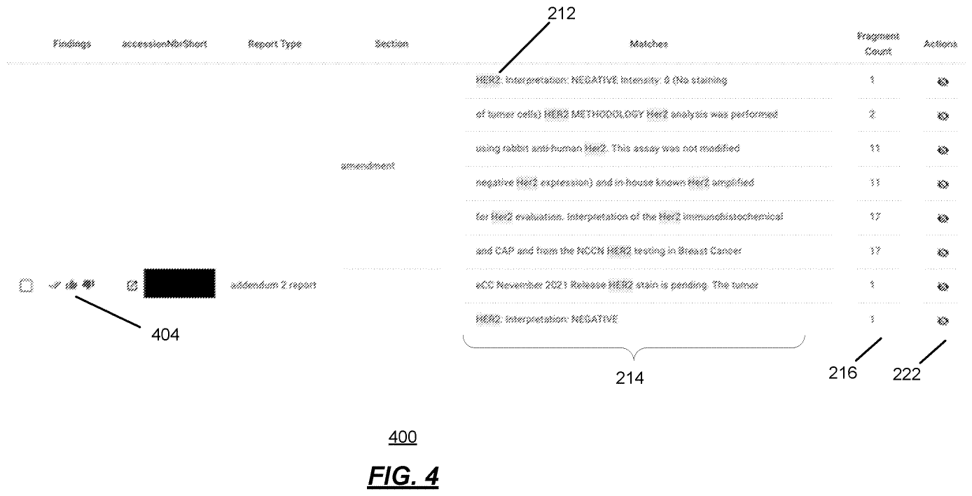

FIG. 4 shows a GUI 400 to illustrate the ability for the system to load in the results of an NLP algorithm for quality control (QC) purposes. The system can ingest results of an NLP algorithm, allowing the user to further interrogate those results by validating true positives, true negatives, false positives & false negatives. The system has functions 404 (e.g., thumbs up, thumbs down) to record the results of the QC efforts to provide specific data to help refine the NLP algorithm to obtain optimal accuracy. The GUI may offer further functionality, such as “select”; term highlighting, and actions (e.g. hide toggle).

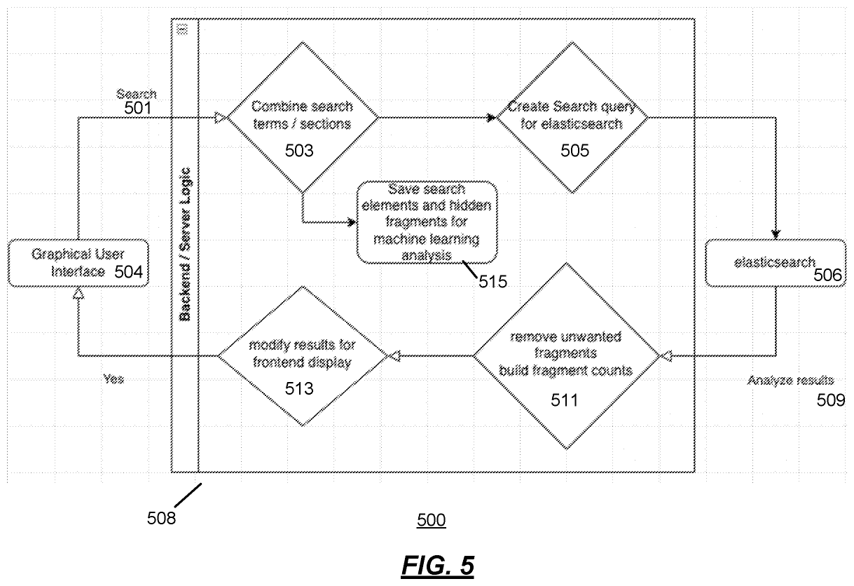

FIG. 5 illustrates a system flow diagram according to principles described herein. Referring to FIG. 5, a search system 500 according to principles described herein may include a graphical user interface 504 and a backend search system 508. The graphical user interface 504 may interface with the backend search engine 508 through any appropriate means, e.g., via the internet or cloud, in which the backend systems are housed in a server or distributed servers, or, e.g., in a dedicated processing system networked with the graphical user interface in a dedicated and/or private network or stand-alone system. Referring again to FIG. 5, a search request 501 from the graphical user interface 504 is transmitted to/received by backend system 508. The search request 501 comprises a term or set of terms in natural language for which the user wishes to retrieve records from a storage repository in the backend system. The records may include any number of natural language records, e.g., medical records, which may have standardized language, but, more likely, has multiple terms or combination of terms having the same or similar meaning.

Upon receipt of the search request 501, the backend server 508 performs a method, including combining search terms/sections 503. The server 508 may combine the search terms by reordering and combining the terms into a format that is machine readable. The backend server 508 may save the search elements and hidden “fragments” for machine learning analysis 515. During the machine learning analysis, the terms are fed into one or more machine learning algorithms to determine alternative ways to express the search terms.

The backend server creates a search query 505 for Elastisearch 506, or the like, using the combined search terms/sections 510. Using Elastisearch 506 or other appropriate search engine, the stored records are searched 507, and the results analyzed 509. The backend processing system removes unwanted fragments and counts the various fragments 511 to provide with presentation to a user via the graphical user interface 504. The unwanted fragments may be displayed fragments that were selected by the user or otherwise indicated by the user to be unwanted through the user interface.

The results are then adjusted for presentation at the graphical user interface 513 and transmitted back to the graphical user interface 504, where the user's system (e.g., a computer or workstation), receives the modified search results and presents them on the graphical user interface 504 for the user to view and manipulate, e.g., by filtering, ordering, truncating or otherwise honing the search results using tools provide to the user via GUI 504.

The combination of NLP and dynamic user input is an improvement over existing methods with increased sensitivity and specificity. The system is intended to work broadly with text-based documentation, additionally allowing functionality to easily validate natural language processing algorithms.

Another improvement over the prior art is the ability to give real-time statistics and frequencies to the user on specific terms searched, immediately informing them on the overall prevalence of those terms across hundreds of thousands of text documents within seconds.

### FFPE Search of Pathology Reports

While pathology reports currently exist primarily as an electronic medical record, the information remains as free text containing semi-structured elements. Associated with these pathology reports are tissue repositories that exist primarily as formalin fixed paraffin embedded (FFPE) samples that are vital to all types of healthcare related research. The present system has shown great utility in qualifying FFPE tissue samples in lieu of having a discrete inventory of FFPE material. The system has been used to search and qualify specific fragments of text to hone in on FFPE blocks of interest significantly reducing the time to find biospecimen of interest.

### Example 1—Qualification of Triple Negative Breast Cancer (TNBC) Cases within Pathology Reports

The diagnosis of TNBC, which is an aggressive form of breast cancer is a combination of 3 molecular based diagnostic evaluations (estrogen receptor, progesterone receptor, human epidermal growth factor receptor 2) all having a negative result. Qualifying this specific diagnosis can be informatically challenging given the numerous ways negative results can be described within pathology reports. Compounding the problem, not all 3 measures are guaranteed to reside on a single diagnostic report, requiring multiple path report/results to be evaluated to determine a single instance of TNBC. In a proof-of-concept setting, the system was found to have little difficulty validating NLP algorithms designed to target this specific diagnosis. The system was used to validate results across all 3 diagnostic measures with great specificity and sensitivity.

Academic medical centers/health research facilities require methods/technology to extract useful information reliably and consistently from the many text-based information sources (e.g., Pathology Reports, Radiology Reports, electronic medical record provider documents and notes, or the like) in support of various research and operational efforts. The market has yet to produce a product(s) that can tackle this significant problem in any real fashion. Within initial pilot efforts, the system has shown an ability to achieve quick results with great sensitivity and specificity qualifying pathology cases with complex and specific criteria. The framework is additionally designed to work with multiple reporting types including but not limited to; radiology reports, text based clinical documentation, state healthcare provider reports, documents, notes and other text based clinical documentation or the like.

In another aspect of the present disclosure, the system and method allow for quality control (QC) of natural language processing search processes. Users have the ability to perform advanced text searching on any report type/sub-types to facilitate case finding with the ability to export either identified or de-identified case lists. Some users of the system will have the additional ability to load results of an NLP algorithm to facilitate NLP algorithm QC. The user will utilize the same advanced text searching capability to validate the accuracy of the algorithm, with functionality to annotate specific QC findings (i.e., false negatives, false positives, true negatives, true positives etc.).

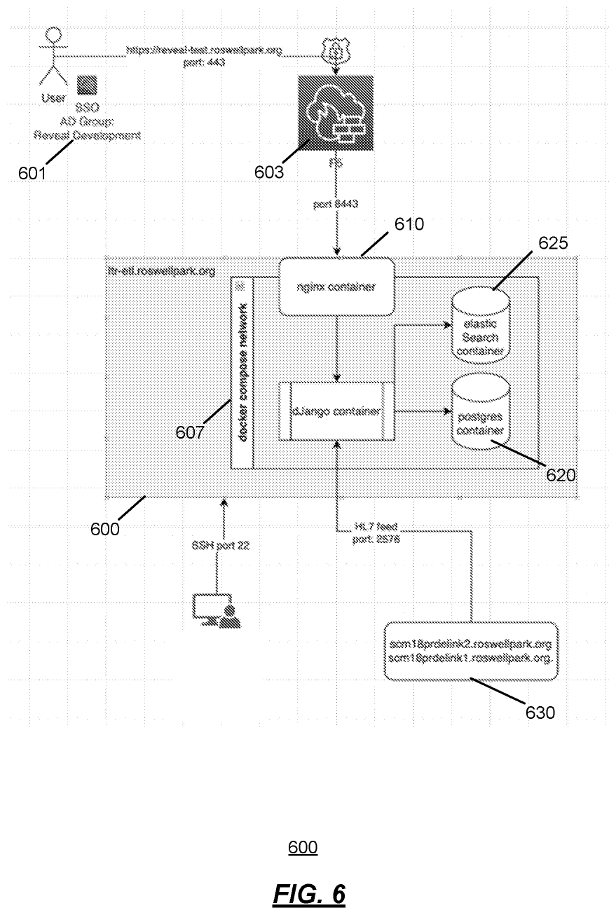

FIG. 6 illustrates a system diagram according to principles described herein, in which access is limited to within an organization or group to preserve patient anonymity. In lieu of a closed system, information may be developed by and/or received from an honest broker such that anonymized patient data is searched.

As illustrated, the system 600 includes several components including, but not limited to, a django container 605, a nginx container 610, a postgres container 620, and an elastic search container 625 executed within a docker compose network 607. The various components may be executed together or separately by one or more general purpose computing devices such as the computing device 700.

The django container 605 may take a user request and may convert it to an Elastic search query for the elastic search container 625. The django container 605 may further receive results of the search from the elastic search container 625, may format the results, and may present the formatted results to the user. The nginx container 610 may be a web server/load balancer. The postgres container 620 may be a relational database that stores user and raw unstructured data.

Referring to FIG. 6, data may be fed from a source clinical system 630 via real-time Hl7 feeds, loaded into the system 600 on a nightly basis, or provided to the system 600 by any other method. Security access may be controlled utilizing organizational enterprise active directory authentication, such that organizational password strength rules are applied. Auditing of searches may be performed, for which the data can be used to support any information security, privacy, or regulatory audit processes.

A user 601, using a computing device, may connect to the system 600. In the example shown, the user 600 connects via an optional firewall 603. The user 601 may provide a search query to the system 600, and the system 600 may generate search results as described above.

As contemplated herein, various open-source technologies may be used to underlie an implementation of the presently disclosed system. Table 1, below, lists an exemplary set of open-source technologies and their related purposes and licenses.

TABLE 1

| # | Technology | Purpose | License |
|---|---|---|---|
| 1 | Python | Programming language used to write | Python Software |
| | | extraction, transformation, and loading | Foundation License |
| | | (ETL) code. | |
| 2 | Django | Web framework used for building the web- | 3-clause BSD |
| | | portal backend. | |
| 3 | Django | Integrates with Django to provide REST-API | 3-clause |
| | Restframework | features used by the frontend communicate | |
| | | with the backend. | |
| 4 | Simple JWT | Provides support for Web Token | MIT License |
| | | Authentication for active directory | |
| | | Authentication. | |
| 5 | ADFS Authentication | Provides support Active directory | BSD-2-Clause License |
| | for Django | authentication for Django. | |
| 6 | django-model-utils | A supporting package for Django for keeping | BSD-3-Clause License |
| | | track of creation and modification dates of | |
| | | rows in database tables. | |
| 7 | python-dotenv | Supports accessing database credentials in a | BSD-3-Clause License |
| | | safe way. | |
| 8 | Gunicorn | A Python Web Server Gateway Interface | MIT License |
| | | HTTP server. | |
| 9 | Pandas | Python package for data analysis. | BSD-3-Clause License |
| 10 | Lifelines | A survival analysis package for Python used to | MIT License |
| | | generate Kaplan-Meier curve. | |
| 11 | Elasticsearch | Main database that supports fast searching of | Elastic License 2.0 |
| | | tumors and events. | |
| 12 | MariaDB | Database for user authentication, workspace | GPLv2, LGPLv2.1 |
| | | management, search management, and logging. | (client libraries) |
| 13 | mysqlclient | Allows Python to connect to MariaDB | GPL-2.0 License |
| 14 | SQLite3 | Used for storing extracted and transformed | Public Domain |
| | | data. | |
| 15 | Angular | Frontend technology that powers the web-portal | MIT License |
| 16 | Angular Material | Provides support for website layout, Ul | MIT License |
| | | components, and themes. | |
| 17 | PrimeNG | Provides additional Ul components | MIT License |
| 18 | Angular ng-select | Provides multiselect Ul component | MIT License |
| 19 | Nginx | Webserver for serving the backend and | 2-clause BSD |
| | | frontend | |
| 20 | Docker | Allows running services as self-contained | Apache License 2.0 |
| | | Docker containers | |

FIG. 7 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 7, an exemplary system for implementing aspects described herein includes a computing device, such as computing device 700. In its most basic configuration, computing device 700 typically includes at least one processing unit 702 and memory 704. Depending on the exact configuration and type of computing device, memory 704 may be volatile (such as random access memory (RAM)), non-volatile (such as read-only memory (ROM), flash memory, etc.), or some combination of the two. This most basic configuration is illustrated in FIG. 5 by dashed line 706.

Computing device 700 may have additional features/functionality. For example, computing device 700 may include additional storage (removable and/or non-removable) including, but not limited to, magnetic or optical disks or tape. Such additional storage is illustrated in FIG. 7 by removable storage 708 and non-removable storage 710.

Computing device 700 typically includes a variety of computer readable media. Computer readable media can be any available media that can be accessed by the device 700 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 704, removable storage 708, and non-removable storage 710 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by computing device 700. Any such computer storage media may be part of computing device 700.

Computing device 700 may contain communication connection(s) 712 that allow the device to communicate with other devices. Computing device 700 may also have input device(s) 714 such as a keyboard, mouse, pen, voice input device, touch input device, etc. Output device(s) 716 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

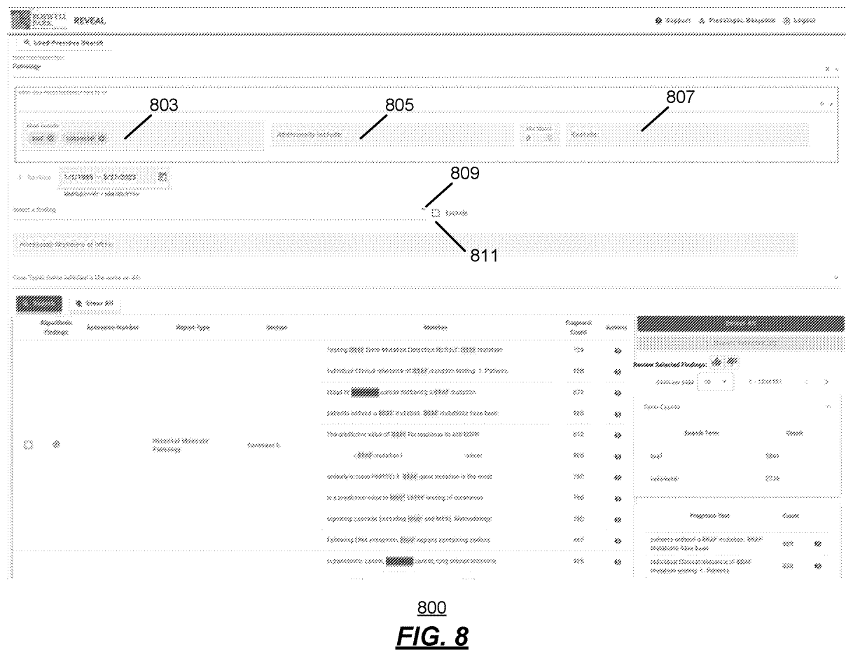

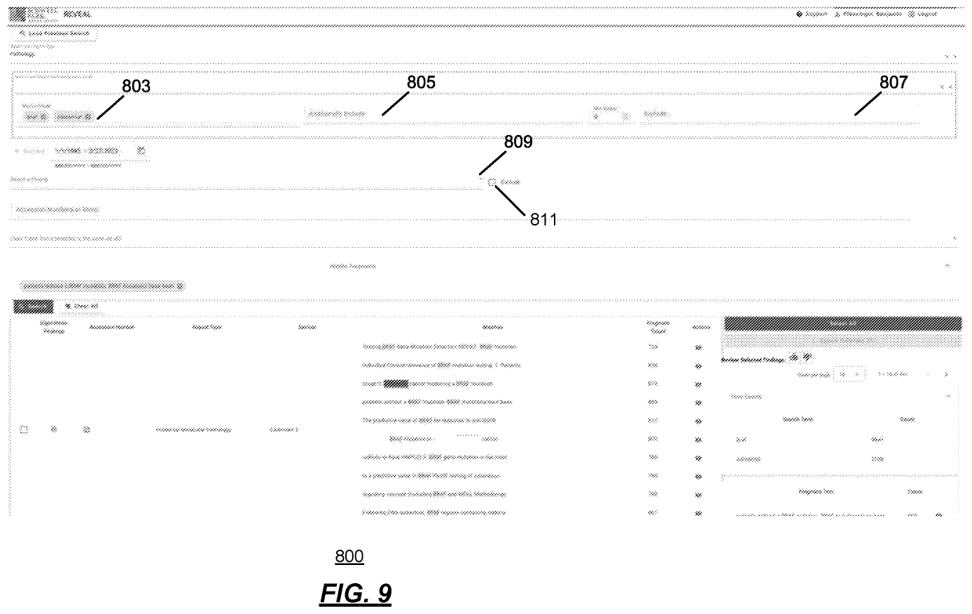

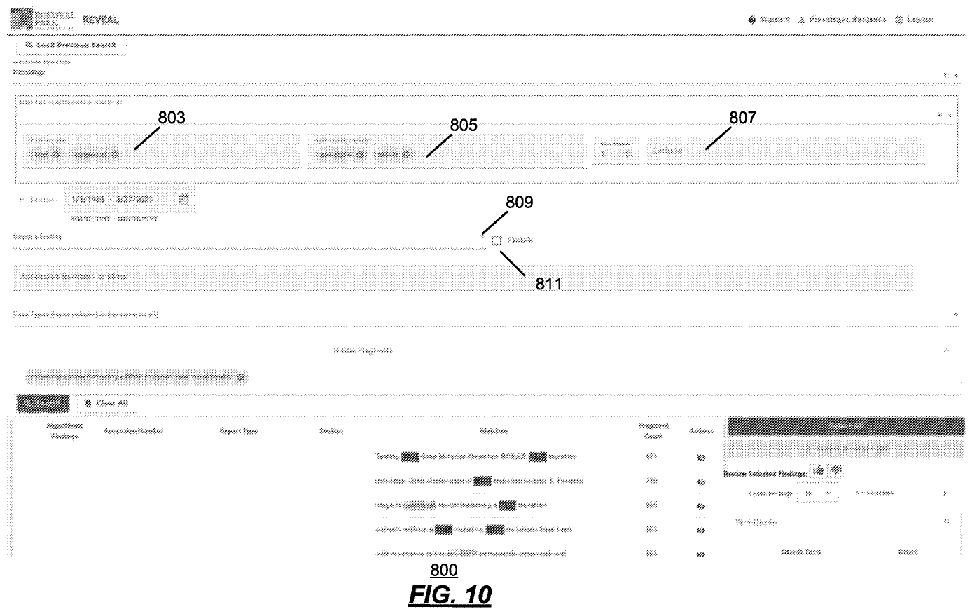

FIGS. 8-10 are screens shot of an example graphical user interface (GUI) 800 for conducting a search according to principles described herein. FIGS. 8 and 9 show entered search terms “braf” and “colorectal” in the “must include” field 803. This means that all search results will contain the term “braf” and “colorectal”. The search can also include any terms that may be included (“additionally include” field 805), which may be matched with a minimum number of matches within a document. The searcher could also exclude document from the result according to the “exclude” field 807 in the graphical user interface 800. The GUI 800 may also include a field 809 for selecting various findings, using a drop down menu, for example. For each entry in the drop down menu 809, the searcher may exclude that finding from the search results using the exclude field 811. The findings in drop down menu 809 may be fragments of the resulting documents, where each fragment includes one, some or all of the search terms with a predetermined number of words before and after each search term being displayed so that the searcher may get an understanding of the context of the search result. The searcher may include or exclude any number of the fragments using this dropdown 809, or may do so as described above to refine the search results. The rightmost panel of the GUI 800 illustrates term and fragment counts for the searcher. FIG. 10 illustrates implementation of the “additionally include feature”, with a minimum match of 1.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions, and arrangement of the exemplary embodiments without departing from the scope of the present disclosure.

While various embodiments of the present invention have been described above, it should be understood that they have been presented by way of example only, and not limitation. It will be apparent to persons skilled in the relevant art that various changes in form and detail can be made therein without departing from the spirit and scope of the present invention. Thus, the breadth and scope of the present invention should not be limited by any of the above-described exemplary embodiments, but should be defined only in accordance with the following claims and their equivalents.

1. A system for performing unstructured search using natural language processing, comprising:
a memory comprising executable instructions; and
a processor configured to execute the executable instructions and cause the system to:
receive a natural language search query comprising a search term from a user;
combine search terms and generate a search query specific to a search engine using the combined terms;
run the search query using the search engine, whereby the search engine accesses a repository of unstructured documents to conduct the search to find occurrences of the search term;
produce search results comprising a plurality of fragments, wherein each fragment includes the search term plus a predetermined number of words before and after the search term as appearing in each occurrence of the search term;
remove unwanted fragments and count the number of times remaining fragments of documents including words;
modify the search results as appropriate for display on user graphical user interface; and
deliver modified search results to the graphical user interface.

2. The system of claim 1, wherein the search engine is elastisearch.

3. The system of claim 1, further comprising further comprising executable code, that upon execution after delivering the modified search results further causes the system to:
receive additional filtering input from the user via the graphical user interface, wherein the additional filtering input includes an instruction of “must include the fragment” in the search results, “additionally include the fragment” in the search results, or “exclude the fragment” from the search results;
update the search results according to the additional filtering input; and
deliver the updated search results to the graphical user interface.

4. The system of claim 3, after delivering the updated search results, the executable code, upon execution, further causes the system to perform the steps of claim 4 upon receipt of further additional filtering input from the user via the graphical user interface.

5. The system of claim 1, further comprising executable code, that upon execution, further causes the system to suppress a certain fragment from the search results upon receipt of an input to hide the certain fragment.

6. The system of claim 5, whereby the input to hide is instructed by a toggle button at the graphical user interface.

7. The system of claim 1, wherein the system further comprises a records repository storing the unstructured documents for search.

8. The system of claim 1, further comprising executable code, that upon execution, causes the system to update a natural language processing query algorithm based on input from the graphical user interface excluding or suppressing certain fragments from the search result.

9. A method for performing a natural language search of unstructured documents, comprising:
receiving a natural language search query comprising a search term from a user;
combining search terms and generate a search query specific to a search engine using the combined terms;
running the search query using the search engine, whereby the search engine accesses a repository of unstructured documents to conduct the search to find occurrences of the search term;
producing search results comprising a plurality of fragments, wherein each fragment includes the search term plus a predetermined number of words before and after the search term as appearing in each occurrence of the search term;
removing unwanted fragments and counting the number of times remaining fragments of documents including words;
modifying the search results as appropriate for display on user graphical user interface; and
delivering modified search results to the graphical user interface.

10. The method of claim 9, wherein the search engine is elastisearch.

11. The method of claim 9, further comprising:
receiving additional filtering input from the user via the graphical user interface, wherein the additional filtering input includes an instruction of “must include the fragment” in the search results, “additionally include the fragment” in the search results, or “exclude the fragment” from the search results;
updating the search results according to the additional filtering input; and
delivering the updated search results to the graphical user interface.

12. The method of claim 11, further comprising after delivering the updated search results, performing the steps of claim 11 upon receipt of further additional filtering input from the user via the graphical user interface.

13. The method of claim 9, further comprising, suppressing a certain fragment from the search results upon receipt of an input to hide the certain fragment.

14. The method of claim 13, wherein the input to hide is instructed by a toggle button at the graphical user interface.

15. The method of claim 9, wherein the system further comprises a records repository storing the unstructured documents for search.

16. The method of claim 9, further comprising updating a natural language processing query algorithm based on input from the graphical user interface excluding or suppressing certain fragments from the search result.

17. A non-transitory computer readable medium comprising instructions that, when executed by a processor of a processing system, cause the processing system to perform a method, the method comprising:
receiving a natural language search query comprising a search term from a user;
combining search terms and generate a search query specific to a search engine using the combined terms;
running the search query using the search engine, whereby the search engine accesses a repository of unstructured documents to conduct the search to find occurrences of the search term;
producing search results comprising a plurality of fragments, wherein each fragment includes the search term plus a predetermined number of words before and after the search term as appearing in each occurrence of the search term;
removing unwanted fragments and count the number of times remaining fragments of documents including words;
modifying the search results as appropriate for display on user graphical user interface; and
delivering modified search results to the graphical user interface.

18. The non-transitory computer readable medium of claim 17, wherein the search engine is elastisearch.

19. The non-transitory computer readable medium of claim 17, the method further comprising:
receiving additional filtering input from the user via the graphical user interface, wherein the additional filtering input includes an instruction of “must include the fragment” in the search results, “additionally include the fragment” in the search results, or “exclude the fragment” from the search results;
updating the search results according to the additional filtering input; and
delivering the updated search results to the graphical user interface.

20. The non-transitory computer readable medium of claim 17, the method further comprising suppressing a certain fragment from the search results upon receipt of an input to hide the certain fragment.
